(19) United States
(12) Patent Application Publication
(10) Pub. No.: US 2002/0066273 A1
(43) Pub. Date: Jun. 6, 2002

(54) Plate fin and combustor using the plate fin

(75) Inventors: Tsuyoshi Kitamura, Takasago-shi (JP); Katsunori Tanaka, Takasago-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI HEAVY INDUSTRIES, LTD., Tokyo (JP)

(21) Appl. No.: 09/996,913

(22) Filed: Nov. 30, 2001

(30) Foreign Application Priority Data
Dec. 4, 2000 (JP) 2000-368839
Dec. 5, 2000 (JP) 2000-370019

(51) Int. Cl. F02C 7/12

(52) U.S. Cl. 60/737; 60/752

(57) ABSTRACT

This invention provides a plate fin which can attain low pollution combustion without the loss of pressure. The plate fin includes an internal wall panel which forms an internal wall of a combustion chamber, an external wall panel facing the internal wall panel and forming a layer-form air flow passage between the internal wall panel and the external wall panel, and a plurality of cooling fins disposed in the layer-form air flow passage. The internal wall panel has a cooling air outlet, and the external wall panel has a plurality of cooling air inlets, both of which communicate with the layer-form air flow passage. Each of the cooling fins has heat transfer plates which are disposed parallel to the direction of cooling air flow through the layer-form air flow passage and connection plates which connect the heat transfer plates to each other.

### BACKGROUND OF THE INVENTION

1. Field of the Invention

This invention relates to a plate fin for forming a combustion chamber of a gas turbine combustor or the like, and to a combustor including the plate fin.

2. Description of Related Art

A gas turbine generally includes, as main components, a compressor, a combustor, and a turbine. The compressor and the turbine are connected to each other by means of a main shaft. The combustor is connected to the outlet of the compressor, from which a working fluid which is highly pressurized at the compressor is supplied to the combustor. The high-pressure working fluid supplied by the compressor is heated by the combustor to a predetermined turbine inlet temperature, and the obtained high-temperature and high pressure working fluid is then supplied to the turbine. The high-temperature and high-pressure working fluid is expanded in a cylinder of the turbine, as it passes between a stator blade and a rotor blade disposed on the main shaft of the turbine. Thereby, the main shaft is rotated, so that power is generated. In case of a gas turbine, the shaft power can be obtained by subtracting from the total generated power the power consumed by rotating the compressor. Therefore, the shaft power can be used as a driving source by connecting an electric power generator to the end of the main shaft, for example.

In the following, the structure of the gas turbine combustor will be briefly explained.

In FIG. 16, a combustor 10 is shown. The combustor 10 is equipped with a premixing nozzle 12 along the central axis of the internal cylinder 11. The internal cylinder 11 is a circular cylinder with both ends open. The premixing nozzle 12 includes a pilot burner 13 and a plurality of main burners 1. The pilot burner 13 is provided in the central position which coincides with the central axis of the premixing nozzle 12. The plurality of main burners 1 are disposed at even intervals so as to surround the pilot burner 13. Therefore, the central axis of the pilot burner 13 is the central axis of the internal cylinder 11.

The pilot burner 13 of the premixing nozzle 12 includes a pilot fuel tube 14 and pilot swirlers 15. The pilot fuel tube 14 is a circular cylinder of which one end is connected to a fuel supply source which is not shown, so that pilot fuel is supplied to the pilot fuel tube 14 from the fuel supply source. At the other end of the pilot fuel tube 14, a pilot fuel nozzle 14a is formed so as to open toward the combustion chamber 10a of the combustor 10 which is formed in the internal cylinder 11. Thus, the pilot fuel is supplied to the combustion chamber 10a from the pilot fuel nozzle 14a. The pilot swirlers 15 have a twisted shape, and are fixed to the circumferential portions of the pilot fuel tube 14. The pilot swirlers 15 give a swirling motion to the air flow which passes through the pilot swirlers 15. Thereby, the air flow is discharged to the surroundings of the pilot fuel nozzle 14a.

The pilot fuel supplied from the pilot fuel nozzle 14a bums the swirled air flow as combustion gas to generate flames in the combustion chamber 10a. Thus, flames generated by the pilot burners 13 are used to generate flames at the main burner 1.

The main burner 1 of the premixing nozzle 12 includes a main fuel supply conduit 2 and main swirlers 5. The main fuel supply conduit 2 is a circular cylinder in which a fuel passage is formed. One end of the main fuel supply conduit 2 is connected to a fuel supply source, which is not shown, in order to supply main fuel to the main fuel supply conduit 2. The other end of the main fuel supply conduit 2 is closed. The main swirlers 5 have a twisted shape, and are fixed on the circumferential portions of the main fuel supply conduit 2. The main swirlers 5 give a swirling motion to the air flow passing the peripheral portion of the main fuel supply conduit 2.

The main burners 1 discharge the main fuel gas, which is introduced through the main fuel supply conduit 2 to a fuel discharge outlet, into the air flow from the fuel discharge outlet. Thereby, the fuel gas and the air are premixed, so that a premixed gas is formed. When the premixed gas passes through the main swirlers 5, the premixed gas is swirled by the main swirlers 5, and subsequently is led to the area around of the pilot burner 13. Then, the premixed gas is ignited by the flames generated by the pilot burner 13 described above.

The internal cylinder 11 is formed using a plate fin 21, which can form a film layer of cooling air for cooling the combustion chamber 10a.

The plate fin 21 includes a fin ring 22 (an internal wall panel) forming an internal wall of the combustion chamber 10a and an external wall panel 23 forming an external wall of the combustion chamber 10a. The external wall panel 23 is disposed above the fin ring 22 with a predetermined interval therebetween.

In the fin ring 22, a plurality of grooves 24 are formed parallel to each other and to face the external wall panel 23. In each of the grooves 24, a cooling air outlet 26 is formed to open at the downstream end of the groove 24. Each of the grooves 24 is closed at its upstream end.

Cooling air inlets 25 are formed at the upstream side of the external wall panel 23, so as to communicate with the grooves 24. Thereby, air surrounding the combustion chamber 10a can flow, as cooling air, into the grooves 24 from the cooling air inlets 25.

When the combustion chamber 10a of the combustor 10 is formed by the internal cylinder 11 which is formed by the aforementioned plate fin 21, cooling air flows into the grooves 24 of the fin ring 22 from the cooling air inlets 25 of the external wall panel 23 during combustion. After the cooling air runs through the grooves 24, the cooling air flows into the combustion chamber 10a from the cooling air outlets 26, which forms film layers of the cooling air along the internal wall of the combustion chamber 10a located downstream. That is, the cooling air can cool the internal cylinder 11 by flowing through the grooves 24 (that is, by convection cooling), and then by forming the film layers of the cooling air along the internal wall of the combustion chamber 10a (that is, by film cooling). Thus, the internal wall of the combustion chamber 10a is cooled by the cooling air, and burning damage to the internal cylinder 11 of the combustion chamber 10a can be prevented.

As described above, by using the aforementioned plate fin 21 as the internal cylinder 11 of the combustion chamber 10a, burning damage to the internal cylinder 11 can be prevented by convection cooling and film cooling. However, it is difficult to further suppress the amount of NOx emitted from the combustor, because the temperature for combustion has been raised to improve the efficiency of the combustion in recent years, which requires much air for cooling, resulting in a decrease of the air for combustion. Therefore, a plate fin having improved cooling performance characteristics which can prevent burning damage without increasing the loss of pressure is required.

### SUMMARY OF THE INVENTION

The present invention has been made in view of the aforementioned circumstances, and aims to provide a plate fin having a superior cooling performance characteristics which can prevent burning damage without the loss of pressure and which can provide low pollution combustion by suppressing the decrease of the air for combustion, and aims to provide a combustor using a plate fin.

The present invention provides a plate fin comprising: an internal wall panel which forms an internal wall of a combustion chamber; an external wall panel which faces the internal wall panel to form a layer-form air flow passage between the internal wall panel and the external wall panel; and a plurality of cooling fins disposed in the layer-form air flow passage; wherein the internal wall panel has a cooling air outlet communicating with the layer-form air flow passage at its downstream end with respect to the direction of cooling air flow through the layer-form air flow passage; the external wall panel has a plurality of cooling air inlets communicating with the layer-form air flow passage at its upstream side with respect to the direction of the cooling air flow through the layer-form air flow passage; and each of the cooling fins has heat transfer plates which are disposed parallel to the direction of the cooling air flow through the layer-form air flow passage and connection plates which contact the heat transfer plates to each other.

The cooling fins may be fixed to the internal wall panel. The length of the heat transfer plate may be set to be within a range which enables formation of an initial boundary layer along the heat transfer plate. The interval between the adjacent cooling fins in a direction parallel to the direction of the cooling air flow through the layer-form air flow passage may be within a range which enables elimination of back turbulence flows caused by cooling fins disposed upstream with respect to the direction of the cooling air flow. Each of the cooling fins preferably has three heat transfer plates and two connection plates, in which the connection plates are arranged perpendicular to the heat transfer plates and each of the connection plates is connected to two heat transfer plates at both ends.

Moreover, the present invention provides a combustor comprising: a premixing nozzle having a pilot burner disposed on a central axis of the premixing nozzle and a plurality of main burners disposed around the pilot burner; and a cylindrical combustion chamber which contains the premixing nozzle, wherein the cylindrical combustion chamber is formed by the aforementioned plate fins.

Moreover, the present invention provides a plate fin comprising: an internal wall panel which forms an internal wall of a combustion chamber; and an external wall panel which faces the internal wall panel and is separated from the internal wall panel by an interval; wherein the internal wall panel has a plurality of grooves forming cooling air flow passages between the internal wall panel and the external wall panel, a plurality of swirl generators formed on rear surfaces of the grooves in the internal wall panel, and a plurality of cooling air outlets communicating with the cooling air flow passages at their downstream ends with respect to the flowing direction of cooling air flowing through the cooling air flow passage; and the external wall panel has a plurality of cooling air inlets communicating with the cooling air flow passages at the upstream sides with respect to the direction of the cooling air flow through the cooling air flow passage.

The swirl generators may comprise exhaust nozzles communicating with the cooling air flow passages, from which a portion of the cooling air flowing through the cooling air flow passages is discharged to generate swirls. Alternatively, the swirl generators may comprise protruding portions protruding from the rear surfaces of the grooves in the internal wall panel.

Moreover, the present invention provides a combustor comprising: a premixing nozzle having a pilot burner disposed on a central axis of the premixing nozzle and a plurality of main burners disposed around the pilot burner; and a cylindrical combustion chamber which contains the premixing nozzle, wherein the cylindrical combustion chamber is formed by the aforementioned plate fins.

Moreover, the present invention provides a combustor comprising: a premixing nozzle having a pilot burner disposed on a central axis of the premixing nozzle and a plurality of main burners disposed around the pilot burner; and a cylindrical combustion chamber which contains the premixing nozzle, wherein the cylindrical combustion chamber is formed by a plate fin having a structure in which the plate fin having the exhaust nozzles is disposed downstream of the plate fin having the protruding portions, with respect to the direction of cooling air flow through the cooling air flow passage.

### BRIEF DESCRIPTION OF DRAWINGS

FIG. 1 is a partially cut away perspective view of a plate fin according to one embodiment of the present invention.

FIG. 2 is a horizontal sectional view of a plate fin according to one embodiment of the present invention.

FIG. 3 is a plane view of a cooling fin included in a plate fin according to one embodiment of the present invention.

FIG. 4 is a plane view of a cooling fin included in a plate fin according to one embodiment of the present invention.

FIG. 5 is a perspective view of a plate fin according to one embodiment of the present invention.

FIG. 6 is a sectional side elevation of a plate fin according to one embodiment of the present invention.

FIG. 7 is a transverse sectional view of a plate fin according to one embodiment of the present invention.

FIG. 8 is a transverse sectional view of a portion of a plate fin according to one embodiment of the present invention, which illustrates the direction of cooling air discharged from an exhaust nozzle formed in the plate fin.

FIG. 9 is a perspective view of an exhaust nozzle disposed in a plate fin according to one embodiment of the present invention, which illustrates the direction of cooling air discharged from the exhaust nozzle and the movement of cooling air of a film layer formed along an internal wall of the plate fin.

FIG. 10 is a perspective view of a plate fin according to one embodiment of the present invention.

FIG. 11 is a sectional side elevation of a plate fin according to one embodiment of the present invention.

FIG. 12 is a transverse sectional view of a plate fin according to one embodiment of the present invention.

FIG. 13 is a transverse sectional view of a portion of a plate fin according to one embodiment of the present invention, which illustrates the direction of cooling air of the film layer colliding with a protruding portion in the plate fin.

FIG. 14 is a perspective view of a protruding portion disposed in a plate fin according to one embodiment of the present invention, which illustrates the movement of cooling air of a film layer formed along an internal wall of the plate fin.

FIG. 15 is a perspective view of a plate fin according to one embodiment of the present invention.

FIG. 16 is a sectional side elevation of a portion of a combustor according to one embodiment of the present invention.

FIG. 17 is a partially cut away perspective view of a plate fin of prior art.

FIG. 18 is a cross-sectional view of a plate fin of prior art.

### DETAILED DESCRIPTION OF THE INVENTION

In the following, various embodiments of a plate fin and a combustor using the plate fin, according to the present invention will be explained with reference to the drawings.

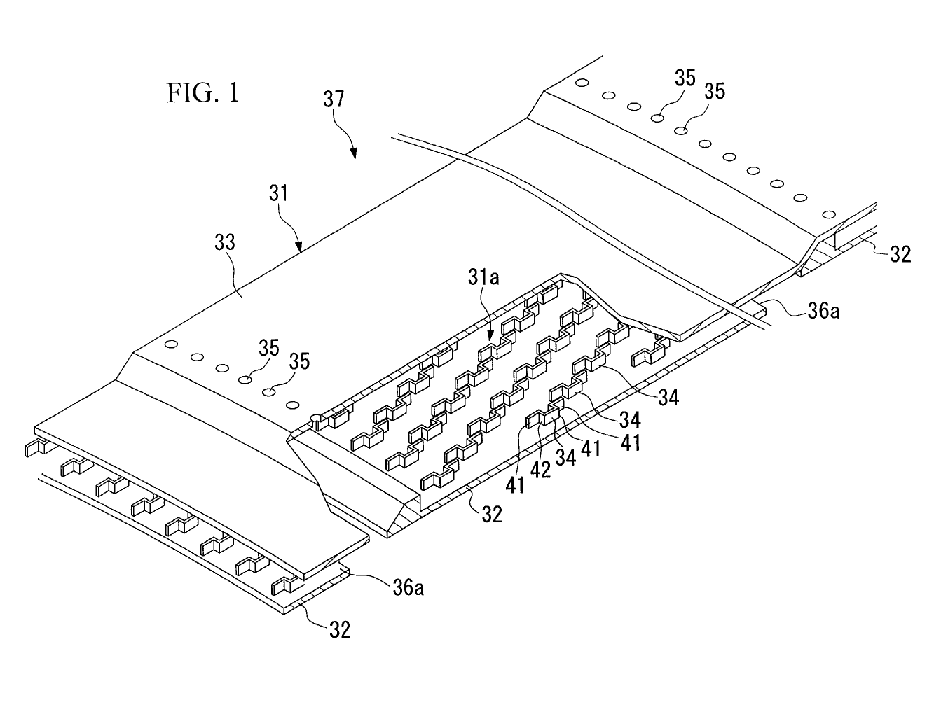

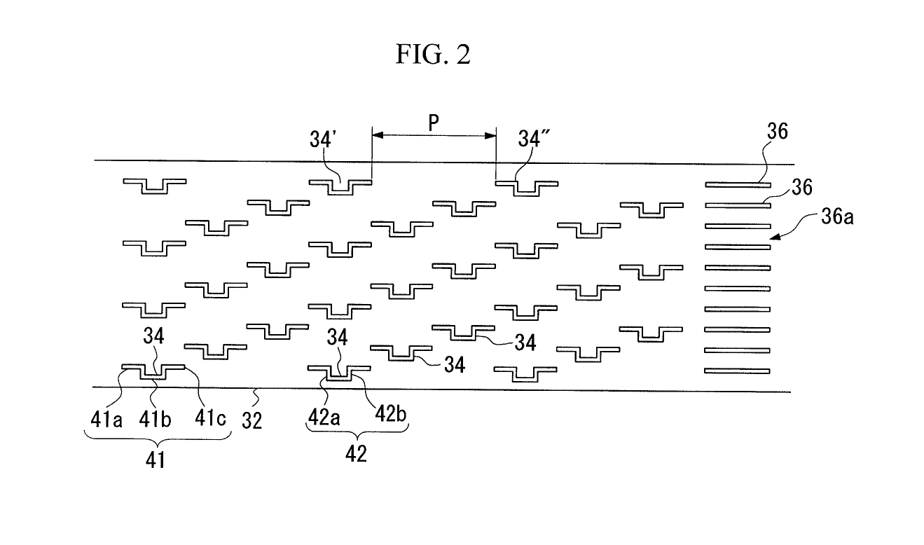

In FIGS. 1 and 2, a plate fin 31 used as an internal cylinder 37 forming the combustion chamber 30a of a combustor 30 according to one embodiment of the present invention is shown. Although there are no particular limitations, the plate fin 31 is preferably made of hastelloy, or the like, and preferably has a width of 30 to 1,000 mm, a length of 100 to 700 mm, and a thickness of 3 to 8 mm. The plate fin 31 includes a fin ring 32 (an internal wall panel) which forms an internal wall of the combustion chamber 30a (that is, which forms an internal surface of the internal cylinder 37) and an external wall panel 33 which forms an external wall of the combustion chamber 30a (that is, which forms an external surface of the internal cylinder 37). The external wall panel 33 faces the fin ring 32 so as to form a layer-form air flow passage 31a between the external wall panel 31 and the fin ring 32. The layer-form air flow passage 31a preferably has a depth of 2 to 5 mm.

A plurality of cooling fins 34 are disposed in the layer-form air flow passage 31a and are fixed to the fin ring 32.

A plurality of cooling air inlets 35 are formed at the upstream side of the external wall panel 33, so as to communicate with the layer-form air flow passage 31a at the upstream side of the layer-form air flow passage 31a. From the cooling air inlets 35, air surrounding the combustion chamber 30a flows into the layer-form air flow passage 31a as cooling air. Although the cross-sectional shape of the cooling air inlet 35 is not particularly limited, the preferable cross-sectional shape is a circle having a diameter of 2 to 5 mm.

A cooling air outlet 36a is formed at the downstream end of the fin ring 32, so as to communicate with the layer-form air flow passage 31a at the downstream side of the layer-form air flow passage 31a. From the cooling air outlet 36a, the cooling air flowing through the layer-form air flow passage 31a is discharged into the combustion chamber 30a along the internal wall of the combustion chamber 30a (that is, the internal surface of the internal cylinder 37).

A plurality of partition plates 36 are disposed parallel to each other in the layer form air flow passage 31a and are fixed to the fin ring 32 at its downstream side near the cooling air outlet 36a. Through these partition plates 36, the cooling air is discharged from the cooling air outlet 36a into the combustion chamber 30a along the internal wall of the combustion chamber 30a. The partition plate 36 is preferably made of hastelloy, or the like, and preferably has a width of 2 to 5 mm, a length of 10 to 30 mm, and a height of 2 to 5 mm.

When the combustion chamber 30a of the combustor 30 is formed by the internal cylinder 37 which is formed by the aforementioned plate fin 31, the cooling air flowing from the cooling air inlets 35 of the external wall panel 33 into the layer-form air flow passage 31a is flows through the partition plates 36 from the cooling air outlet 36a into the combustion chamber 30a during combustion, which forms a film layer of cooling air along the internal wall of the combustion chamber 30a at the downstream side. That is, the internal surface of the internal cylinder 37 is cooled by convection when the cooling air flows through the layer-form air flow passage 31a between the plate fin 31a nd the external wall panel 32, and is then cooled by the film layer of cooling air, which is formed along the internal surface of the internal cylinder 37. Thereby, burning damage to the internal cylinder 37 forming the combustion chamber 30a can be prevented.

The cooling fins 34 disposed in the layer-form air flow passage 31a between the plate fin 31a nd the external wall panel 32 are arranged in a plurality of lines, each of which is parallel to the partition plates 36. The cooling fins 34 have heat transfer plates 41 and connection plates 42. The heat transfer plates 41 are disposed parallel to the flow of the cooling air flowing from the cooling air inlets 35 to the cooling air outlet 36a. The connection plates 42 are disposed to connect to the adjoining heat transfer plates 41.

In FIG. 2, each of the cooling fins 34 has three heat transfer plates 41 including a first, second, and third heat transfer plate (41a, 41b, 41c), and two connection plates 42 including a first and second connection plate (42a, 42b). The heat transfer plate 41 is preferably made of hastelloy, or the like, and preferably has a width of 0.5 to 2 mm, a length of 5 to 20 mm, and a height of 2 to 5 mm. The connection plate 42 is preferably made of hastelloy, or the like, and preferably has a width of 0.5 to 2 mm, a length of 5 to 20 mm, and a height of 2 to 5 mm. The heat transfer plates 41 are disposed parallel to each other along the flow of the cooling air. The first heat transfer plate 41a is disposed upstream of the second heat transfer plate 41b which is disposed upstream of the third heat transfer plate 41c. The first heat transfer plate 41a and the third heat transfer plate 41c are arranged in a line with an interval corresponding to the length L of the heat transfer plate 41. The first connection plate 42a is perpendicularly disposed at the upstream end of the second heat transfer plate 31b, and the second connection plate 42b is perpendicularly disposed at the downstream end of the second heat transfer plate 31b. The first heat transfer plate 41a is connected to the second heat transfer plate 41b through the first connection plate 42a, and the third heat transfer plate 41c is connected to the second heat transfer plate 41b through the second connection plate 42b.

As shown in FIG. 4, the first connection plate 42a may be disposed to connect the first heat transfer plate 41a and the second heat transfer plate 41b, while inclining towards the upstream end of the second heat transfer plate 41b, and the second connection plate 42b may be disposed to connect the second heat transfer plate 41b and the third heat transfer plate 41c, while inclining towards the downstream end of the second heat transfer plate 41b.

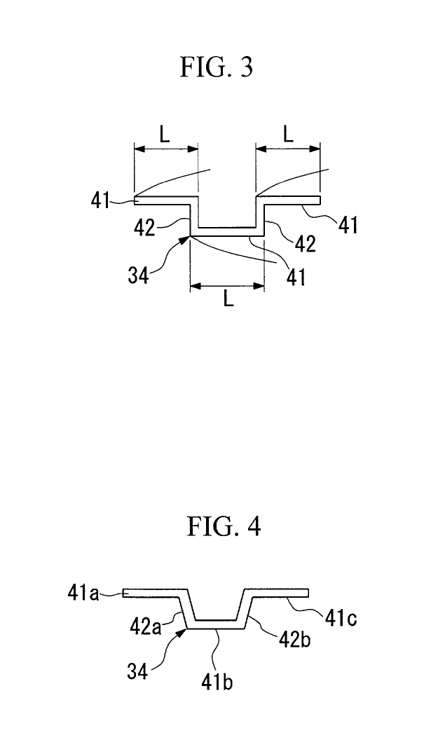

As shown in FIG. 3, the length L of the heat transfer plate 41 is preferably set to within a range which enables the formation of an initial boundary layer along the heat transfer plate 41, into which heat of the combustion chamber 30a is transferred. Although the length L is suitably decided in accordance with combustion conditions such as the combustion temperature or the like, the length L is preferably set within a range from 2 to 10 mm, more preferably from 2 to 5 mm. The initial boundary layer is effectively renewed, immediately after the initial boundary layer into which the heat of the combustion chamber 30a is transferred is removed by the cooling air flow through the layer-form air flow passage 31a. Thus, the initial boundary layer is maintained to be cooled, and the heat transferred from the combustion chamber 30a can effectively be transferred between the cooling air and the heat transfer plate 41 through the initial boundary layer.

Moreover, as shown in FIG. 2, the cooling fins 34 are disposed at intervals P in the direction parallel to the partition plate 36. That is, a cooling fin 34′ disposed upstream is separated by an interval P from an adjoining cooling fin 34″ disposed downstream. The interval P is preferably set within a range which enables elimination of back turbulence flow which is caused by the cooling fin 34′ disposed upstream and which affects the formation of the initial boundary layer by disturbing the cooling air flow. That is, the interval P is set to be a predetermined distance by which back turbulence flow elimination effects can be sufficiently obtained. Although the interval P is suitably determined in accordance with combustion conditions such as the combustion temperature or the like, the interval P is preferably set within a range from 18 to 90 m, more preferably from 18 to 45 mm.

As described above, by using the aforementioned plate fin 31 in which a plurality of cooling fins 34 are disposed along the direction of flowing of the cooling air in the layer-form air flow passage 31a, the heat transfer plates 41 of the cooling fins can effectively transfer the heat of the combustion chamber 30a to the cooling air, and the cooling air can effectively cool the layer-form air flow passage 31a by convection without the loss of pressure. Moreover, since the cooling air discharged from the cooling air outlet 36a forms a film layer of cooling air along the internal wall of the combustion chamber 30a after cooling the layer-form air flow passage 31a by convection, the internal wall of the combustion chamber 30a can be effectively cooled by the film layer of cooling air.

Thus, since the plate fin 31 enables cooling of the combustion chamber 30a by achieving satisfactory film cooling and the satisfactory convection cooling without increasing the amount of air used for cooling, the amount of NOx emissions can be reduced by suppressing the decrease of the amount of air for combustion, despite the increase in the temperature for combustion in accordance with the improvement of the combustion efficiency.

When the length L of the heat transfer plate 41 in a direction parallel to the partition plate 36 is set to be a predetermined length which enables the formation of the initial boundary layer along the heat transfer plate 41, the boundary layer is effectively removed and renewed by the cooling air flow, and thereby, the heat can be effectively transferred between the heat transfer plate 41 of the cooling fins and the cooling air, as a result of which the cooling air can more effectively cool the layer-form air flow passage 31a by convection (boundary layer renewal effects).

Moreover, since the interval P between the cooling fins 34 adjacent in a direction parallel to the partition plate 36 along the direction of the cooling air flow through the layer-form air flow passage 31a is set to be a predetermined value which is sufficient to eliminate back stream which is caused by the cooling fins 34 disposed upstream and which affects the formation of the initial boundary layer along the heat transfer plates 41 of the cooling fin 34 disposed downstream by disturbing the cooling air flow, the efficiency of renewing the boundary layer can be improved, as a result of which the efficiency of the heat transfer between the cooling air and the cooling fins can be improved, and the cooling air can more effectively cool the layer-form air flow passage 31a by convection.

The combustor 30 includes a premixing nozzle having a pilot burner disposed on a central axis of the premixing nozzle and a plurality of main burners disposed around the pilot burner and includes a cylindrical combustion chamber 30a which contains the premixing nozzle. The cylindrical combustion chamber 30a is formed by the internal cylinder 37 made from the aforementioned plate fin 31. Specifically, the internal cylinder 37 is formed by connecting a plurality of the plate fins 31, preferably 1 to 32 plate fins 31, and by then forming the connected plate fins 31 into a cylindrical shape. The premixing nozzle is disposed at upstream side of the plate fin 31. Since the combustion chamber 30a is formed by the aforementioned plate fins 31, the combustion chamber 30a achieves effective convection cooling and film cooling, by which a satisfactory cooling effect can be achieved.

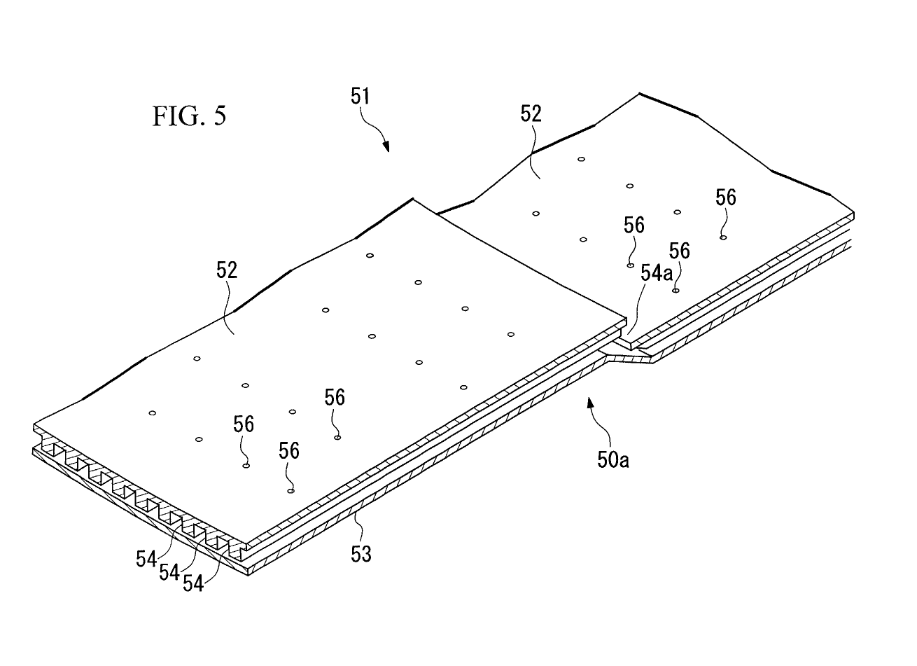

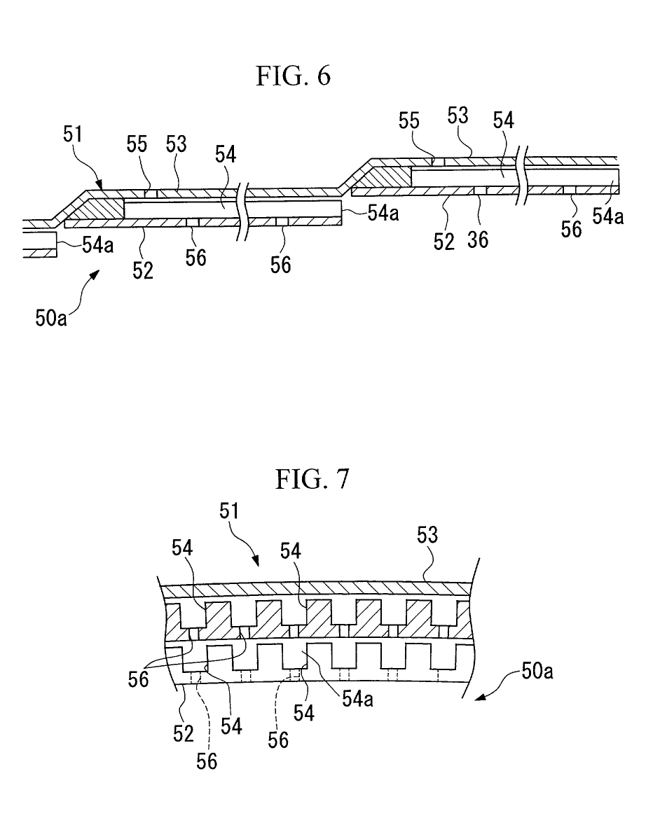

In FIGS. 5 to 7, a plate fin 51 used for an internal cylinder forming a combustion chamber 50a of the combustor 50 according to one embodiment of the present invention is shown.

The plate fin 51 includes a fin ring 52 (an internal wall panel) forming an internal wall of the combustion chamber 50a (i.e., the internal surface of the internal cylinder) and an external wall panel 53 forming an external wall of the combustion chamber 50a (i.e., the external surface of the internal cylinder). Although there are no particular limitations, the plate fin 51 is preferably made of hastelloy, or the like, and preferably has a width of 30 to 100 mm, a length of 100 to 700 mm, and a thickness of 3 to 8 mm. The external wall panel 53 faces the fin ring 52 and is separated from the fin ring 52 by an interval.

In the fin ring 52, a plurality of grooves 54 are formed parallel to each other on the surface opposite to the external wall panel 53, by which cooling air flow passages are formed between the fin ring 52 and the external wall panel 53. Although there are no particular limitations, the groove 54 is preferably has a width of 2 to 5 mm, a length of 100 to 700 mm, and a height of 2 to 5 mm. A plurality of cooling air outlets 54a are formed at the downstream ends of the grooves 54 to communicate with the combustion chamber 50a and the grooves 54. In contrast, the upstream end of the fin ring 52 is closed by the external wall panel 53.

At the upstream side of the external wall panel 53, cooling air inlets 55 are formed to communicate with each of the groove 54 of the fin ring 52. From the cooling air inlets 55, air surrounding the internal cylinder flows into the grooves 54 as cooling air. Although the cross-sectional shape of the cooling air inlet 35 is not particularly limited, the preferable cross-sectional shape is a circle having a diameter of 2 to 5 mm.

Moreover, a plurality of exhaust nozzles 56 are formed to communicate with the combustion chamber 50a as swirl generators on the fin ring 52 along each axis of the grooves 54 with a predetermined interval, preferably with an interval within a range from 10 to 60 mm. That is, the fin ring 52 communicates with the combustion chamber 50a through the cooling air outlets 54a and the exhaust nozzles 56. The exhaust nozzles 56 formed in the adjoining grooves 54 are displaced in the axial direction. Although the cross-sectional shape of the exhaust nozzle 56 is not specifically limited, the preferable cross-sectional shape of the exhaust nozzle 56 is a circle having a diameter of 2 to 5 mm.

When the combustion chamber 50a of the combustor 50 is formed by the internal cylinder which is formed by the aforementioned plate fins 51, air flows into the grooves 54 of the fin ring 52 from the cooling air inlets 55 of the external wall panel 53 as cooling air during combustion. After flowing through the grooves 54, the cooling air is discharged from the cooling air outlets 54 into the combustion chamber 50a, by which a film layer of cooling air is formed along the internal wall of the combustion chamber 50a at the downstream side. That is, the cooling air cools the internal cylinder from its inside by convection during flowing through the grooves 54, and then cools the internal cylinder from its internal surface by forming the film layer of cooling air along the internal surface of the internal cylinder, which prevents burning damage to the internal cylinder of the combustion chamber 50a.

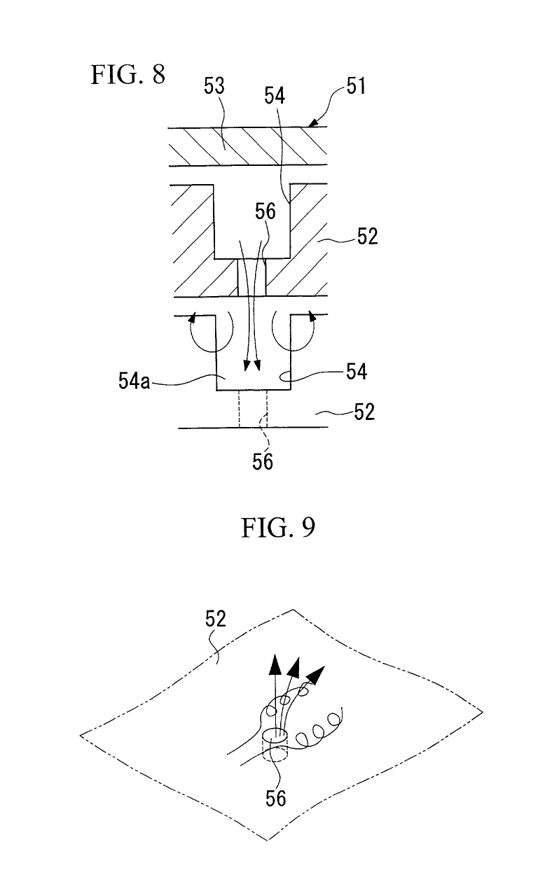

Since the exhaust nozzles 56 are disposed as swirl generators in the fin ring 52, a portion of the cooling air flowing through the grooves 54 is discharged from the exhaust nozzles 56 into the combustion chamber 50a. Then, the cooling air discharged from the exhaust nozzles 56 flows at a right angle into the cooling air forming the film layer of cooling air along the internal wall of the fin ring 52, which forms vertical swirls such as those shown in FIGS. 8 or 9 along the internal wall of the combustion chamber 50a. Thereby, the film layer of cooling air is pressed against the internal wall of the combustion chamber 50a, which results in improving the efficiency of cooling the plate fin 51.

By using the aforementioned plate fin 51 having exhaust nozzles 56 from which a portion of the cooling air is discharged into the film layer formed by the cooling air discharged from the cooling air outlet 54a disposed at the upstream side of the exhaust nozzles 56, the film layer of cooling air can be pressed against the internal wall of the combustion chamber 50a by generating swirls along the internal wall of the combustion chamber 50a, which results in significantly improving the efficiency of cooling the combustion chamber 50a. That is, the efficiency of cooling can be improved at low cost by generating swirls into the film layer of cooling air. Thus, satisfactory film cooling can be achieved without increasing the amount of the used cooling air and without decreasing the amount of air for combustion, which can reduce the amount of NOx emissions despite the increase in temperature for combustion in accordance with the improvement of the combustion efficiency. Moreover, since the plate fin 51 is further cooled by the cooling air flowing through the cooling air flow passages formed by the grooves 54, the efficiency of cooling the plate fin 51 is significantly improved.

The combustor 50 includes a premixing nozzle having a pilot burner disposed on a central axis of the premixing nozzle and a plurality of main burners disposed around the pilot burner and includes a cylindrical combustion chamber which contains the premixing nozzle. The cylindrical combustion chamber 50a is formed by the internal cylinder made from the aforementioned plate fin 51. Specifically, the internal cylinder is formed by connecting a plurality of the plate fins 51, preferably 1 to 32 plate fins 51, and by then forming the connected plate fins 51 into a cylindrical shape. The premixing nozzle is disposed at the upstream side of the plate fin 51. Since the combustion chamber 50a is formed by the aforementioned plate fin 51, the combustion chamber 50a allows effective convection cooling and film cooling, by which satisfactory cooling effects can be achieved.

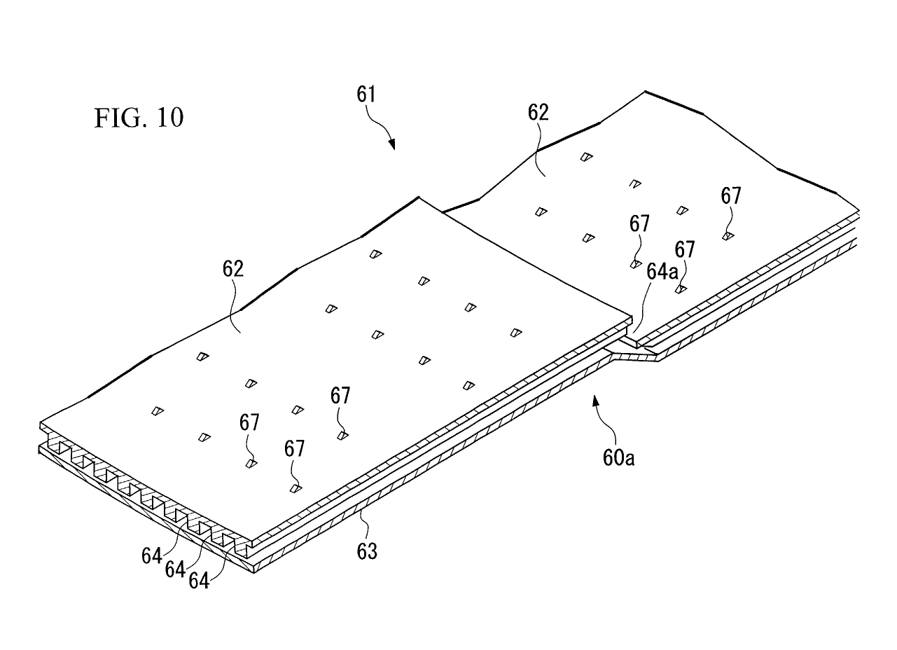

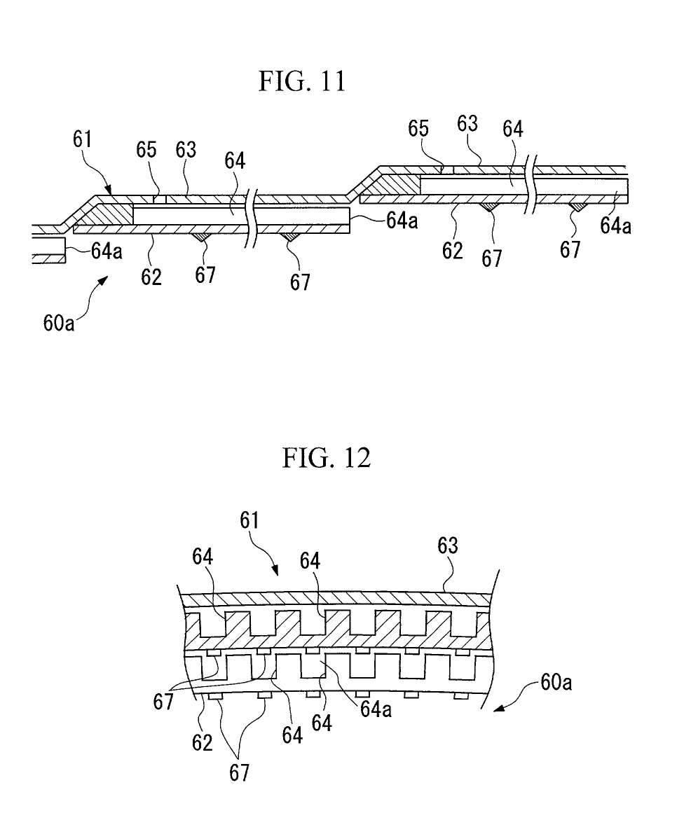

In FIGS. 10 to 12, a plate fin 61 according to another embodiment of the present invention is shown. The plate fin 61 includes a fin ring 62 (an internal wall panel) forming an internal wall of a combustion chamber 60a and an external wall panel 63 forming an external wall of the combustion chamber 60a in a manner similar to that of fin ring 52 except that the fin ring 62 has a plurality of protruding portions 67 as swirl generators instead of the exhaust nozzles 56.

The protruding portions 67 are formed to protrude into the combustion chamber 60a along axes of grooves 64 at predetermined intervals, preferably at intervals of 10 to 60 mm. The shape of the protruding portions 67 when viewed from the side may be triangular, preferably with a length of 1 to 6 mm and a height of 1 to 6 mm. The protruding portions 67 formed onto the rear surfaces of the adjoining grooves 64 are displaced in the axial direction. Thereby, the vertical swirls can further effectively be generated without contacting with each other.

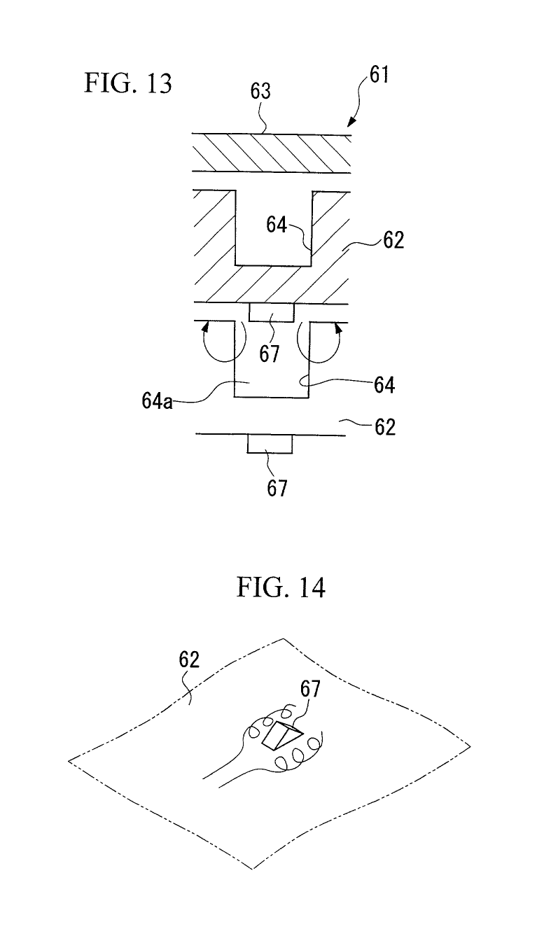

When the plate fin 61 including the fin ring 62 having protruding portions 67 on the rear surface of the grooves 64 is used, the film layer formed by the cooling air flowing along the internal wall of the combustion chamber 60a downstream of the cooling air outlets 64a flows into the protruding portions 67, which forms vertical swirls such as those shown in FIG. 13 or 14 along the internal wall of the combustion chamber 60a. Thereby, the film layer of cooling air is formed to maintain close contact with the internal wall of the combustion chamber 60a, which results in improving the efficiency of cooling the combustion chamber 60a.

Thus, by using the aforementioned plate fin 61, the film layer of cooling air can be formed to maintain close contact with the internal surface of the internal cylinder because the protruding portions 67 generate vertical swirls along the internal surface of the internal cylinder formed by the plate fin 61, resulting in significantly improving the efficiency of cooling the internal cylinder. That is, the efficiency of cooling can be improved at low cost by generating vertical swirls in the film layer of cooling air to decrease the distance between the film layer of cooling air and the internal wall of the fin ring 62.

A combustor according to one embodiment of the present invention includes a premixing nozzle having a pilot burner disposed on a central axis of the premixing nozzle and a plurality of main burners disposed around the pilot burner and includes the cylindrical combustion chamber 60a which contains the premixing nozzle. The cylindrical combustion chamber 60a is formed by the internal cylinder which is formed by the aforementioned plate fins 61. Specifically, the internal cylinder is formed by connecting a plurality of the plate fins 61, preferably 1 to 32 plate fins 61, and by then forming the connected plate fins 61 into a cylindrical shape. The premixing nozzle is disposed at the upstream side of the plate fin 61. Since the combustion chamber 60a is formed by the aforementioned plate fin 61, the combustion chamber 60a allows effective convection cooling and film cooling, by which satisfactory cooling effect can be achieved.

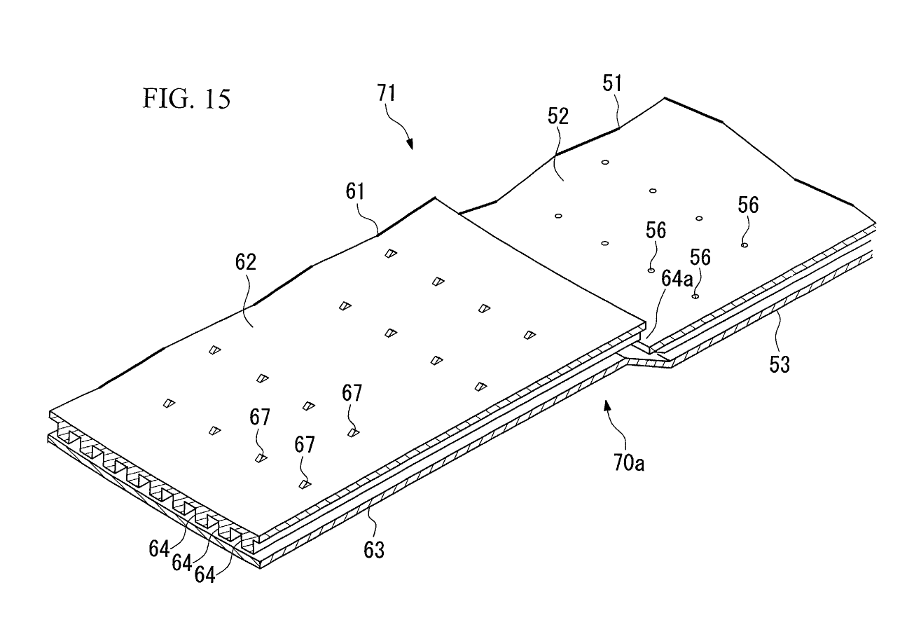

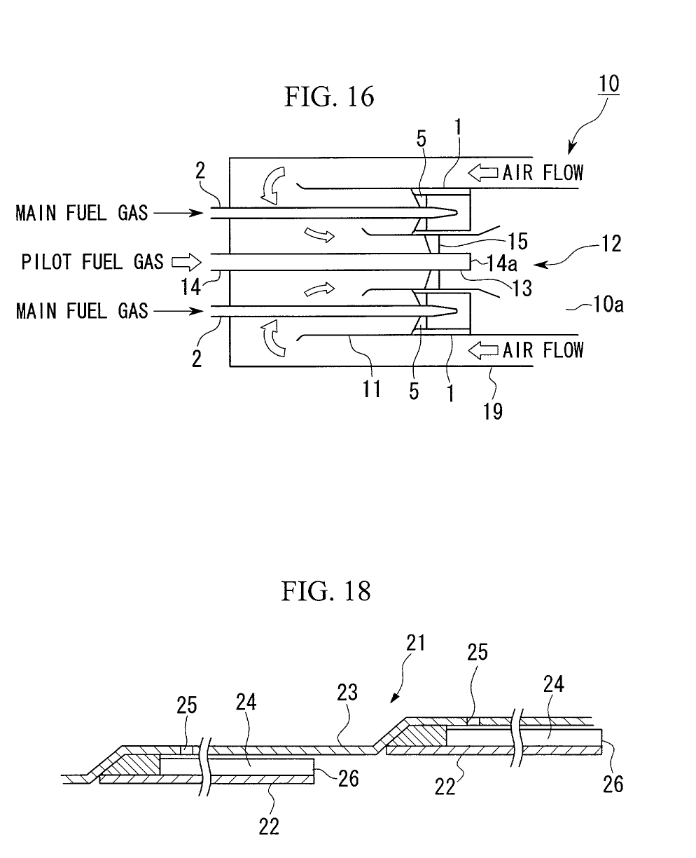

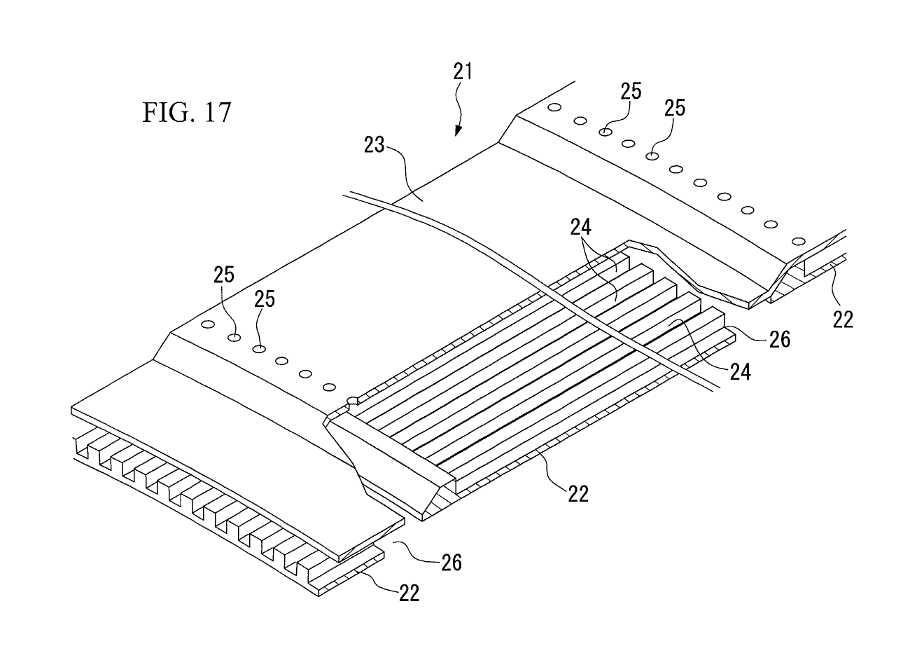

In FIG. 15, a combustor according to another embodiment of the present invention includes a premixing nozzle having a pilot burner disposed on a central axis of the premixing nozzle and a plurality of main burners disposed around the pilot burner and includes a cylindrical combustion chamber 70a which contains the premixing nozzle. The cylindrical combustion chamber 70a is formed by the internal cylinder which is formed by plate fins 71 having a structure combining the aforementioned plate fins 51 with the aforementioned plate fins 61. Specifically, the internal cylinder is formed by connecting the aforementioned plate fin 51 with the aforementioned plate fin 61, and by then forming the obtained plate fin 71 into a cylindrical shape. Preferably, the fin ring 52 having the exhaust nozzles 56 is disposed downstream of the fin ring 62 having the protruding portions 67, with respect to the direction of the cooling air flow through the cooling air flow passage. By disposing the fin ring 52 downstream of the fin ring 62, fuel gas can be diluted by the cooling air discharged from the exhaust nozzles 56 at downstream side, which can prevent damage to a turbine disposed downstream of the combustor.

As described above, by using the plate fin or the combustor according to the present invention, the following effects can be achieved.

When a plurality of cooling fins having the heat transfer plates disposed along the direction of the cooling air flow are disposed in the layer-form air flow passage of the plate fin, the heat can be effectively transferred between the cooling air and the heat transfer plates, by which the layer-form air flow passage can be sufficiently cooled by convection while reducing the loss of pressure. Moreover, after cooling the layer-form air flow passage by convection, the cooling air discharged from the cooling air outlet flows along the internal wall of the combustion chamber to form a film layer of cooling air, by which the internal wall of the combustion chamber can be effectively cooled.

Thus, by using the plate fin, the aforementioned film cooling and convection cooling can be effectively achieved without decreasing the amount of air available for combustion, by which the amount of NOx emission can be reduced despite the increase in temperature for combustion in accordance with the improvement of the combustion efficiency.

When the length of the heat transfer plate is set to be within a range which enables formation of an initial boundary layer along the heat transfer plate, the heat can effectively be transferred between the cooling air and the heat transfer plate through the initial boundary layer which is effectively renewed along the heat transfer plate, and thereby, the efficiency of the convection cooling can be improved.

When the interval between the adjacent cooling fins in a direction parallel to the flow of the cooling air is set to be within a range which enables elimination of back stream caused by the cooling fin disposed at the upstream side, the efficiency of renewing the boundary layer along the heat transfer plates can be improved, by which the efficiency of the heat transfer between the cooling air and the cooling fins can be improved, and the efficiency of the convection cooling can be further improved.

When the cylindrical combustion chamber of the combustor is formed by the aforementioned plate fins, the combustion chamber allows effective convection cooling and film cooling, by which a satisfactory cooling effect can be achieved.

When a plurality of swirl generators which generate vertical swirls in the film layer of cooling air along the internal wall of the plate fin are disposed in the fin ring of the plate fin, the film layer of cooling air can be made to closely contact the internal wall of the combustion chamber, by which the internal wall of the combustion chamber can be very effectively cooled. Thus, by using the aforementioned plate fin, the efficiency of cooling the plate fin by the film layer of cooling air can be improved without increasing the amount of cooling air used and without decreasing the amount of air for combustion, by which the amount of NOx emission can be reduced despite the increased temperature for combustion in accordance with the improvement of the combustion efficiency.

When the swirl generators include exhaust nozzles, a portion of the cooling air is discharged into the film layer of cooling air, by which vertical swirls are generated along the internal wall of the plate fin. Thereby, the film layer of cooling air can be formed closely contacting with the internal wall of the fin ring, which results in improved efficiency of cooling the internal wall of the combustion chamber at low cost.

When the swirl generators include protruding portions, the film layer of cooling air flows into the protruding portions, by which vertical swirls are formed along the internal wall of combustion chamber. Thereby, the film layer of cooling air can be made to closely contact the internal wall of the combustion chamber, which results in improved efficiency of cooling the internal wall of the combustion chamber at low cost.

When the cylindrical combustion chamber of the combustor is formed by the aforementioned plate fins, it is possible to achieve satisfactory cooling of the combustion chamber.

When the combustor includes a combustion chamber formed by plate fins having a structure in which the fin ring containing the exhaust nozzles is disposed at downstream side of a fin ring containing protruding portions, fuel gas discharged from upstream of the exhaust nozzles 56 can be diluted by the cooling air discharged by the exhaust nozzles 56, which can prevent damage to a turbine disposed downstream.

What is claimed is:

1. A plate fin comprising:
an internal wall panel which forms an internal wall of a combustion chamber;
an external wall panel which faces the internal wall panel to form a layer-form air flow passage between the internal wall panel and the external wall panel; and
a plurality of cooling fins disposed in the layer-form air flow passage;
wherein the internal wall panel has a cooling air outlet communicating with the layer-form air flow passage at its downstream end with respect to the direction of cooling air flow through the layer-form air flow passage;
the external wall panel has a plurality of cooling air inlets communicating with the layer-form air flow passage at its upstream side with respect to the direction of the cooling air flowing through the layer-form air flow passage; and
each of the cooling fins has heat transfer plates which are disposed parallel to the direction of the cooling air flow through the layer-form air flow passage and connection plates which connect the heat transfer plates to each other.

2. A plate fin according to claim 1, wherein the cooling fins are fixed to the internal wall panel.

3. A plate fin according to claim 1, wherein the length of the heat transfer plate is within a range which enables formation of an initial boundary layer along the heat transfer plate.

4. A plate fin according to claim 1, wherein the interval between adjacent cooling fins in a direction parallel to the direction of the cooling air flow through the layer-form air flow passage is within a range which enables elimination back stream caused by the cooling fin disposed at the upstream side with respect to the direction of the cooling air flow.

5. A plate fin according to claim 1, wherein each of the cooling fins has three heat transfer plates and two connection plates, in which the connection plates are arranged perpendicular to the heat transfer plates and each of the connection plates is connected to two heat transfer plates at both ends.

6. A combustor comprising:
a premixing nozzle having a pilot burner disposed on a central axis of the premixing nozzle and a plurality of main burners disposed around the pilot burner; and
a cylindrical combustion chamber which contains the premixing nozzle, wherein the cylindrical combustion chamber is formed by the plate fins according to claim 1.

7. A plate fin comprising:
an internal wall panel which forms an internal wall of a combustion chamber; and
an external wall panel which faces the internal wall panel and is separated from the internal wall panel by an interval;
wherein the internal wall panel has a plurality of grooves forming cooling air flow passages between the internal wall panel and the external wall panel, a plurality of swirl generators formed on rear surfaces of the grooves in the internal wall panel, and a plurality of cooling air outlets communicating with the cooling air flow passages at their downstream ends with respect to the direction of cooling air flow through the cooling air flow passage; and
the external wall panel has a plurality of cooling air inlets communicating with the cooling air flow passages at its upstream sides with respect to the direction of the cooling air flow through the cooling air flow passage.

8. A plate fin according to claim 7, wherein the swirl generators comprise exhaust nozzles communicating with the cooling air flow passages, from which a portion of the cooling air flowing through the cooling air flow passages is discharged to generate swirls.

9. A plate fin according to claim 7, wherein the swirl generators comprise protruding portions protruding from the rear surfaces of the grooves in the internal wall panel.

10. A combustor comprising:
a premixing nozzle having a pilot burner disposed on a central axis of the premixing nozzle and a plurality of main burners disposed around the pilot burner; and
a cylindrical combustion chamber which contains the premixing nozzle, wherein the cylindrical combustion chamber is formed by the plate fins according to claim 7.

11. A combustor comprising:
a premixing nozzle having a pilot burner disposed on a central axis of the premixing nozzle and a plurality of main burners disposed around the pilot burner; and
a cylindrical combustion chamber which contains the premixing nozzle, wherein the cylindrical combustion chamber is formed by a plate fin having a structure in which the plate fin according to claim 8 is disposed downstream of the plate fin according to claim 9, with respect to the direction of cooling air flow through the cooling air flow passage.
